(19) United States
(12) Patent Application Publication
(10) Pub. No.: US 2024/0201837 A1
(43) Pub. Date: Jun. 20, 2024

(54) WIRELESS POSITIONING SYSTEMS

(71) Applicant: Peytec Inc., Richmond Hill (CA)

(72) Inventors: Peyman Moeini, Richmond Hill (CA); Akbar Ahmari, Richmond Hill (CA); Furat Al-Obaidy, Richmond Hill (CA); Arghavan Asad, Richmond Hill (CA); Dishan Fernando, Richmond Hill (CA); Xavier Navajothy Fernando, Richmond Hill (CA); Sammy Guergachi, Richmond Hill (CA); Muhammad Jaseemuddin, Richmond Hill (CA); Xiaofeng Li, Richmond Hill (CA); Ryan Murari, Richmond Hill (CA); Farah Mohammadi, Richmond Hill (CA)

(73) Assignee: Peytec Inc., Richmond Hill (CA)

(21) Appl. No.: 18/587,750

(22) Filed: Feb. 26, 2024

Related U.S. Application Data
(63) Continuation of application No. 17/144,857, filed on Jan. 8, 2021, now Pat. No. 11,914,856.
Application No. 17/144,857 is a continuation-in-part of application No. 16/298,819, filed on Mar. 11, 2019, now abandoned.
(60) Provisional application No. 62/971,732, filed on Feb. 7, 2020.
(60) Provisional application No. 62/962,669, filed on Jan. 17, 2020.
(60) Provisional application No. 62/958,475, filed on Jan. 8, 2020.
(60) Provisional application No. 62/640,645, filed on Mar. 9, 2018.
(60) Provisional application No. 62/640,646, filed on Mar. 9, 2018.
(60) Provisional application No. 62/640,649, filed on Mar. 9, 2018.
(60) Provisional application No. 62/640,651, filed on Mar. 9, 2018.

(51) Int. Cl. G06F 3/0485; G06F 3/04845

(52) U.S. Cl. CPC G06F 3/0485; G06F 3/04845; G06F 2203/04803

(57) ABSTRACT

A method for dynamically spatially visualizing in real time or historically tag localization and sensing data in a User Interface through the combined GUI elements of a Floor Layout view. An indoor map view visually indicates tags as colored dots moving within boundaries of Readers. Localization data from these tags are used to position and move them in a spatially accurate way. Playback controls GUI which allows for pausing or to instantly view historical tag localization and sensing data by dragging the playback control's scrubber backwards in time

### CROSS-REFERENCE TO RELATED APPLICATION

This application is a continuation of U.S. patent application Ser. No. 17/144,857, filed Jan. 8, 2021 which claimed the benefit of:
U.S. Provisional Patent Application Ser. No. 62/971,732, filed Feb. 7, 2020; and
U.S. Provisional Patent Application Ser. No. 62/962,669, filed Jan. 17, 2020; and
U.S. Provisional Patent Application Ser. No. 62/958,475, filed Jan. 8, 2020,
   and which was a continuation-in-part of U.S. patent application Ser. No. 16/298,819, filed Mar. 11, 2019, which claimed the benefit of
U.S. Provisional Patent Application Ser. No. 62/640,645, filed Mar. 9, 2018;
U.S. Provisional Patent Application Ser. No. 62/640,646, filed Mar. 9, 2018;
U.S. Provisional Patent Application Ser. No. 62/640,649, filed Mar. 9, 2018; and
U.S. Provisional Patent Application Ser. No. 62/640,651, filed Mar. 9, 2018.

### BACKGROUND OF THE INVENTION

### 1. Field of the Invention

The invention relates to the field of wireless positioning systems.

### 2. Prior Art

There exists great interest in the use of wireless technology to provide for remote monitoring and control. Small, battery-powered transceivers, called tags, are commonly applied (“tagged”) to machines, pallets, etc., to provide for localization of the tagged item through communication with readers. Known systems have relatively undesirable combinations of cost, durability, portability, battery-life and accuracy.

### SUMMARY OF THE INVENTION

The invention relates to improvements in the field of wireless positioning.

Forming one aspect of the invention is a wireless positioning system using swarms of neural networks as taught in U.S. Provisional Patent Application Ser. No. 62/971,732, filed Feb. 7, 2020, incorporated herein in its entirety by reference.

Forming another aspect of the invention is a wireless sensor network location prediction method as taught in U.S. Provisional Patent Application Ser. No. 62/962,669, filed Jan. 17, 2020, incorporated herein in its entirety by reference.

Forming yet another aspect of the invention is a MAC layer protocol for use with wireless positioning networks as taught in U.S. Provisional Patent Application Ser. No. 62/958,475, filed Jan. 8, 2020, incorporated herein in its entirety by reference. Forming yet another aspect is a wireless positioning system, as taught in U.S. patent application Ser. No. 16/298,819, filed Mar. 11, 2019, incorporated herein in its entirety by reference.

What is claimed is:

1. A method for dynamically spatially visualizing in real time or historically tag localization and sensing data in a User Interface through the combined GUI elements of the Floor Layout view comprising:
a. The indoor map view: which visually indicates tags as colored dots moving within the boundaries of Readers wherein localization data from these tags are used to position and move them in a spatially accurate way;
b. The playback controls GUI which allows for pausing or to instantly view historical tag localization and sensing data by dragging the playback control's scrubber backwards in time.

2. A method for importing editing and creating Zones through a GUI, which designate a user defined area within the boundary of a fixed, Reader monitored, area.

3. A method for creating automated workflows using user defined criteria (known as the Trigger), a user defined resulting action (known as the Action) and a user defined scope of which tags and user defined Zones are used to form.
